(19) United States
(12) Patent Application Publication
(10) Pub. No.: US 2023/0368756 A1
(43) Pub. Date: Nov. 16, 2023

(54) Guitar Control System

(71) Applicant: JAMES TALLENT, Miami Beach, FL (US)

(72) Inventor: JAMES TALLENT, Miami Beach, FL (US)

(21) Appl. No.: 18/197,819

(22) Filed: May 16, 2023

Related U.S. Application Data
(60) Provisional application No. 63/342,182, filed on May 16, 2022.

(51) Int. Cl. G10H 1/00

(52) U.S. Cl. CPC G10H 1/0008; G10H 2220/071; G10H 2220/106; G10H 2220/061

(57) ABSTRACT

The present invention is a guitar control system, with level indicators, and an application for an electronic device. The guitar control system may be retrofitted to already existing guitar rig components, or the guitar control system may be integrated into new guitar rig components. The level indicator contains multiple LED lights that light up to show where to position knobs on the guitar rig component to achieve a desired tone. The desired tone may be saved by a user, or the desired tone may be downloaded from a database of existing tones.

### CLAIM OF PRIORITY

This application claims priority to U.S. Application Ser. No. 63/342,182, filed on May 16, 2022, the contents of which are herein fully incorporated by reference in its entirety.

### FIELD OF THE EMBODIMENTS

The field of the present invention and its embodiments relate to a guitar control system with lights to indicate where to turn the knobs on a guitar rig component, and an application to control the system.

### BACKGROUND OF THE EMBODIMENTS

Like anything else, learning how to play the guitar can be difficult. However, learning how to play the guitar is only the beginning when it comes to electric guitars. Not only do guitarists have to learn how to play the instrument, but they also have to learn how to control the tone of the guitar. With almost infinite combinations of effects pedals, guitars, and guitar amps, the possible tones a guitar can have are endless. Memorizing where to turn knobs, and the best position for each knob on the effects pedals, guitar, and guitar amp can take just as long to learn as simply playing the guitar. Learning both how to play guitar and how to control the tone of the guitar, at the same time can be very difficult for beginners.

The difficulty associated with learning how to control the tone of the guitar could be eliminated with a control system that shows a user how to configure the effects pedals, guitar, and guitar amp. A guitar control system with effects pedals, a guitar, and a guitar amp with lights that show a user where to turn the knobs, allows guitar players to use effects more easily. A corresponding app allows new and experienced guitar players to program preset tones, or find preset tones created by other players. Legacy solutions attempt to simplify instrument control systems but fail to provide a control system that shows users where to turn knobs to achieve the desired tone. Examples of guitar control systems are provided below.

For instance, U.S. Pat. No. 7,355,110B2 pertains to an apparatus and method for storing, editing, deleting and visually displaying personal information within a stringed musical instrument. A hand-held type computer located in and forming a portion of the envelope or housing of the stringed musical instrument displays personal information to a user from a display screen.

U.S. Pat. No. 9,595,248B1 pertains to a remotely operable bypass loop device and system that includes a bypass loop device having a wireless communication unit for communicating with a smartphone or other electronic device running a looper application. The looper app generates a virtual representation of the bypass loop device, and functions to selectively engage and disengage sound loops based upon a user input to the app.

U.S. Pat. No. 9,972,295B2 pertains to an apparatus installed in a cellular phone to control a guitar effector loop. The apparatus includes a patch screen display unit for displaying a patch, which is constituted by combinations of the plurality of foot switches and the compactors set to the respective foot switches, on a patch screen of the cellular phone, a bank screen display unit for display a bank constituted by the plurality of patches on a bank screen of the cellular phone, and a control unit performing a control so that the patch screen corresponding to a selected patch is displayed by the patch screen display unit when one patch is selected from the plurality of patches displayed on the back screen.

U.S. Ser. No. 10/127,899B2 pertains to a system and method for interfacing and controlling multiple musical instrument effects modules and pedals on a common platform. The system includes: a system processor; a backplane coupled with the system processor; a plurality of musical instrument effects modules removably inserted into the backplane, a plurality of musical instrument effects pedals removably inserted into the backplane via looper channels.

US20130327201A1 pertains to a programmable pedalboard for a musical instrument. The pedalboard includes a docking station for receiving a removable portable computer that provides a plurality of instrument effects. The docking station is configured to receive an audio signal from a musical instrument and to modify the audio signal from the musical instrument based on at least one instrument effect from the plurality of instrument effects.

WO2019/143364A1 pertains to a guitar multi-effects pedalboard. The pedalboard has one or more footswitches, an electronic display, and a memory storing guitar-effect presets for processing an inputted guitar signal when the processing is triggered by pressing a footswitch. The presets include signal chains with two or more guitar-effect pedal simulators that simulate two or more guitar-effect pedals. The pedalboard also has one or more processors coupled to the electronic display and the memory. The processors are also configured to display, on the electronic display, an image of the signal chains, which includes an image of pedals and an image of existing simulated connections between pedals.

Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

In one aspect, a guitar control system includes at least one level indicator that includes at least one light, a communication module, and a control module, where each of the at least one light corresponds to a position of a control of at least one guitar rig component, and a guitar control application that includes machine-readable instructions for execution on an electronic device includes a processor, and a memory, where the guitar control application is designed to store at least one configuration, and the guitar application is designed to send the at least one configuration to the at least one level indicator, the communication module of the at least one level indicator designed to receive the at least one configuration, and where the control module is designed to read the at least one configuration, and the control module is designed to light up the at least one light based on the at least one configuration.

The guitar control system may also include where the at least one level indicator is designed to retrofit to the at least one guitar rig component.

The guitar control system may also include where the guitar control application is designed to store at least one configuration entered by a first user, and where the first user may access the at least one configuration, and at least one-second user may access the at least one configuration.

The guitar control system may also include where the communication module is designed to communicate via Bluetooth communication protocol.

The guitar control system may also include where the at least one light is a light-emitting diode.

The guitar control system may also include where the electronic device is a smartphone device having a processor, a memory, a communication antenna, and a display. Other technical features may be readily apparent to one skilled in the art from the following figures, descriptions, and claims.

In one aspect, a guitar control system includes at least one guitar rig component, including a housing, at least one control, and at least one level indicator, further includes at least one light, a communication module, and a control module, where each of the at least one light corresponds to a position of a control of at least one guitar rig component, where the at least one control and the at least one level indicator are disposed on the housing, and the at least one level indicator is associated with at least one position of the at least one control, and a guitar control application that includes machine readable instructions for execution on an electronic device includes a processor, and a memory, where the guitar control application is designed to store at least one configuration, and the guitar application is designed to send the at least one configuration to the at least one level indicator, the communication module of the at least one level indicator designed to receive the at least one configuration, and where the control module is designed to read the at least one configuration, and the control module is designed to light up the at least one light based on the at least one configuration.

The guitar control system may also include where the at least one guitar rig component is a guitar effects pedal.

The guitar control system may also include where the at least one guitar rig component is a guitar amplifier.

The guitar control system may also include where the at least one control is a knob, and the at least one light of the level indicator is disposed around the knob. Other technical features may be readily apparent to one skilled in the art from the following figures, descriptions, and claims.

In one aspect, a guitar control system includes a guitar, that includes a body, at least one control, and at least one level indicator, further includes at least one light, a communication module, and a control module, where each of the at least one light corresponds to a position of a control of the guitar, where the at least one control and the at least one level indicator are disposed on the body, and the at least one level indicator is associated with at least one position of the at least one control, and a guitar control application that includes machine readable instructions for execution on an electronic device includes a processor, and a memory, where the guitar control application is designed to store at least one configuration, and the guitar application is designed to send the at least one configuration to the at least one level indicator, the communication module of the at least one level indicator designed to receive the at least one configuration, and where the control module is designed to read the at least one configuration, and the control module is designed to light up the at least one light based on the at least one configuration.

The guitar control system may also include where the at least one control is a knob, and the at least one light of the level indicator is disposed around the knob.

The guitar control system may also include where the at least one light of the level indicator is a light emitting diode. Other technical features may be readily apparent to one skilled in the art from the following figures, descriptions, and claims.

The guitar control system may also include where the at least one guitar rig component is an analog effects pedal.

The guitar control system may also include where the at least one guitar rig component is a digital effects pedal.

The guitar control system may also include where the at least one guitar rig component is a guitar amplifier.

The guitar control system may also include where the at least one guitar rig component is a guitar.

The guitar control system may also include where the at least one light of the level indicator is a light-emitting diode. Other technical features may be readily apparent to one skilled in the art from the following figures, descriptions, and claims.

It is an object of the present invention to provide a guitar control system that shows users how to position knobs on a guitar rig component.

It is an object of the present invention to provide a guitar control system with lights to show a user where to position knobs on a guitar rig component.

It is an object of the present invention to provide a guitar control system that can be retrofitted to already existing guitar rig components.

It is an object of the present invention to provide a guitar control system that works with both analog and digital guitar rig components.

### BRIEF DESCRIPTION OF THE DRAWINGS

FIG. 1 illustrates an aspect of the subject matter in accordance with one embodiment.

FIG. 2A illustrates an aspect of the subject matter in accordance with one embodiment.

FIG. 2B illustrates an aspect of the subject matter in accordance with one embodiment.

FIG. 2C illustrates an aspect of the subject matter in accordance with one embodiment.

FIG. 2D illustrates an aspect of the subject matter in accordance with one embodiment.

FIG. 3 illustrates an aspect of the subject matter in accordance with one embodiment.

### DETAILED DESCRIPTION OF THE EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of an explanation of the present invention, which is not intended to be limited thereto. In fact, those of ordinary skill in the art may appreciate upon reading the present specification and viewing the present drawings that various modifications and variations can be made thereto.

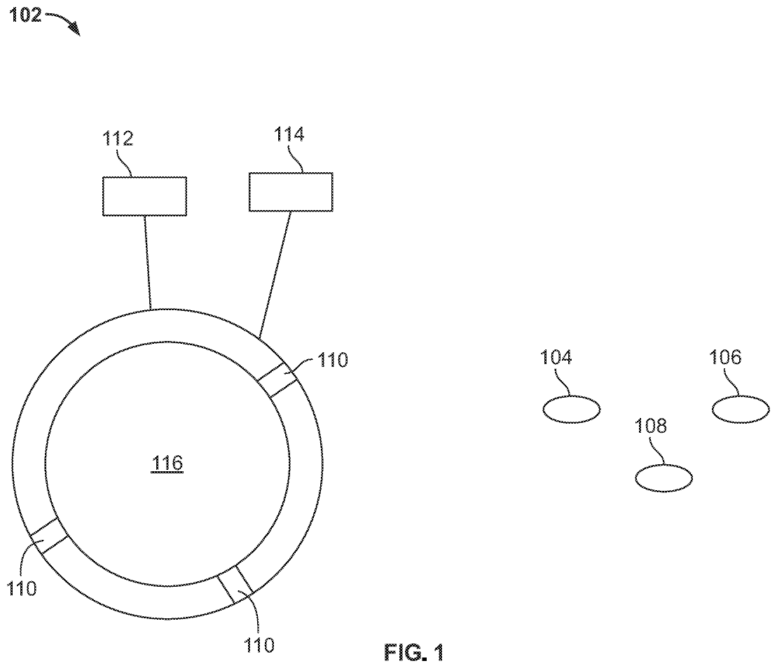

FIG. 1 shows level indicators 102 of a guitar control system. The level indicators 102 may be ring indicators 104, small indicators 106, or slider indicators 108. The level indicators 102 may include at least a communication module 112, a control module 114, and at least one light 110. The communication module 112 may be designed to send and receive wireless communication signals. The communication module 112 may be coupled to at least one light 110, and the control module 114. The communication module 112 may receive signals with instructions for the control module 114. The communication module 112 may be designed to send these instructions to the control module 114. The instructions may include, but are not limited to, what lights 110 the control module 114 should light up, what color the lights 110 should be, and the brightness of the lights 110.

The ring indicator 104 may comprise at least a portion of a ring of lights 110. In the preferred embodiment, the lights 110 are light-emitting diodes (LEDs). The lights 110 may be designed to change to any color. In one embodiment, the ring indicator 104 may comprise at least one physical indicator 116. In this embodiment, at least one physical indicator 116 is a portion of the ring indicator 104 without lights 110. The physical indicator 116 may contain colors and/or a pattern to indicate a position of a knob. In the preferred embodiment, the ring indicator 104 has three physical indicators 116. In this embodiment, each physical indicator 116 indicates a different level. The levels may include a low level, a medium level, and a high level. Each physical indicator 116 may comprise different colors and/or patterns. For example, the low-level physical indicator 116 may comprise a dot pattern comprising two dots, the medium physical indicator 116 may comprise a line pattern comprising two lines, and the high physical indicator 116 may comprise a dot pattern comprising four dots. It is to be appreciated, the physical indicators 116 may comprise any pattern and/or color without deviating from the present disclosure.

The small indicator 106 may comprise at least one LED. The small indicator 106 may be designed to change to any color. The small indicator 106 may be designed to change to any color. In the preferred embodiment, three small indicators 106 may be used together. In this embodiment, a first small indicator 106 may indicate a first position of a switch, a second small indicator 106 may indicate a second position of a switch, and a third small indicator 106 may indicate a third position of a switch.

The slider indicator 108 may comprise a strip of lights 110. In one embodiment, the lights 110 are LEDs. In one embodiment, the slider indicator 108 may comprise at least one physical indicator 116. In this embodiment, the at least one physical indicator 116 is a portion of the slider indicator 108 without lights 110. The physical indicator 116 may contain colors and/or a pattern to indicate a position of a knob. In the preferred embodiment, the slider indicator 108 has three physical indicators 116. In this embodiment, each physical indicator 116 indicates a different level. The levels may include a low level, a medium level, and a high level. Each physical indicator 116 may comprise different colors and/or patterns. For example, the low-level physical indicator 116 may comprise a dot pattern comprising two dots, the medium physical indicator 116 may comprise a line pattern comprising two lines, and the high physical indicator 116 may comprise a dot pattern comprising four dots. It is to be appreciated, the physical indicators 116 may comprise any pattern and/or color without deviating from the present disclosure.

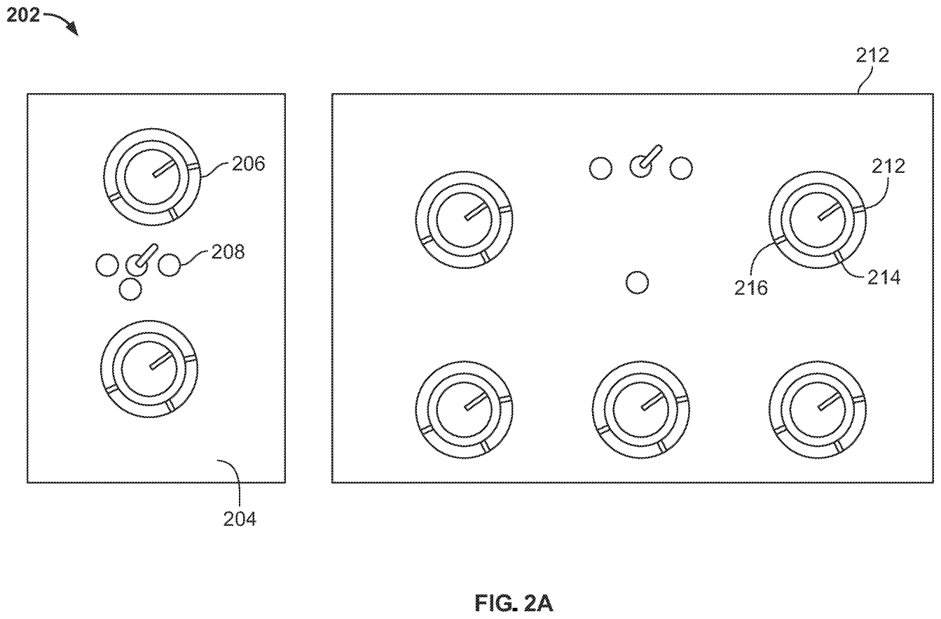

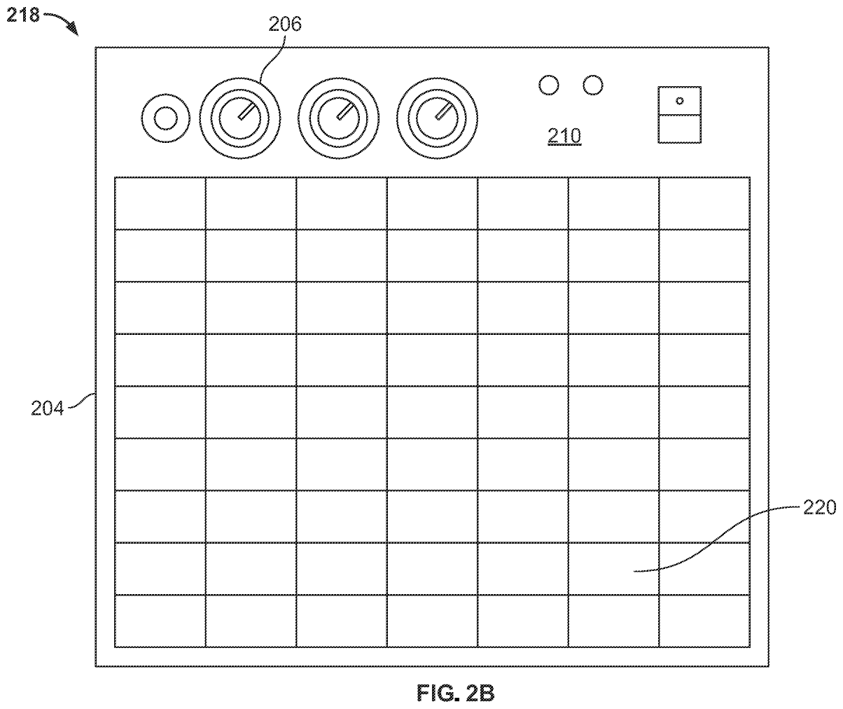

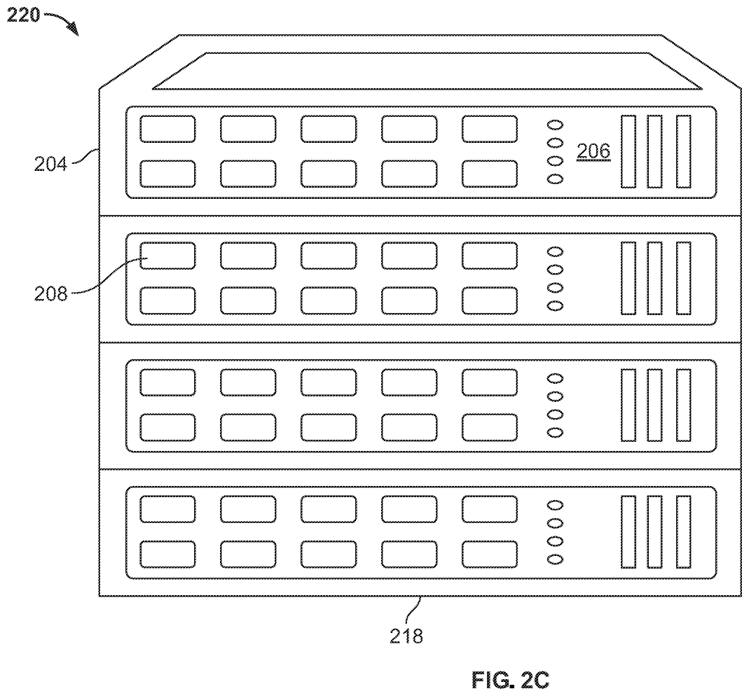

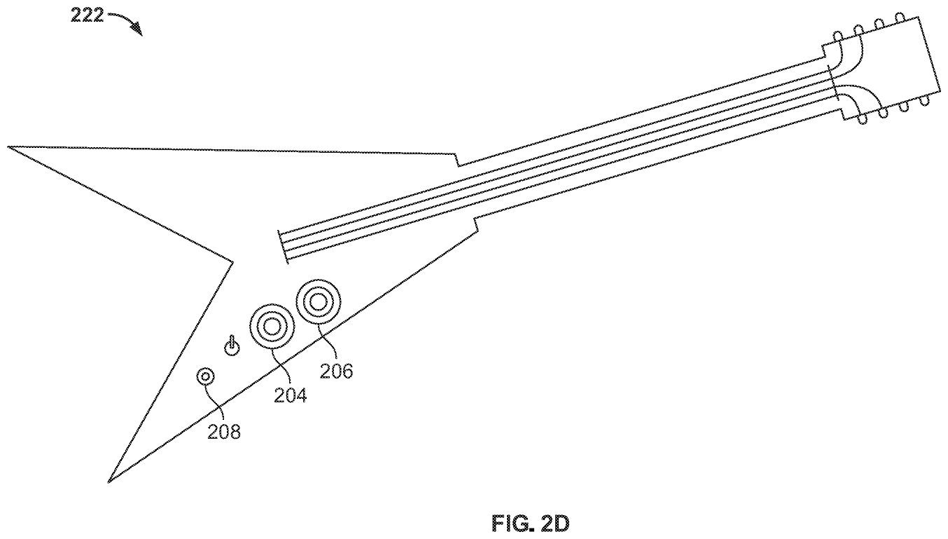

FIG. 2A shows guitar effects pedals 202. The guitar effects pedal may include at least a housing 204, at least one knob 206, switch 208, and/or slider 210. In one embodiment the guitar effects pedal 202 may include at least one switch 208. In another embodiment, the guitar effects pedal 202 may include at least one slider 210. The guitar effects pedal 202 may include at least one level indicator 102. The at least one level indicator 102 may comprise at least one ring indicator 104, at least one small indicator 106, at least one slider indicator 108, or any combination thereof. The at least one level indicator 102 may be coupled to the housing 204. Although the at least one level indicator 102 may be coupled anywhere on the housing 204, in the preferred embodiment, the level indicator 102 is coupled to the housing 204 at a location corresponding to a knob 206, switch 208, or slider 210.

In one embodiment, the housing 204 contains the communication module 112, the control module 114, and a circuit. The circuit may comprise any necessary components of a guitar effects pedal 202 known in the art. The housing 204 may be made out of metal, plastic, wood, or any other material known in the art.

In one embodiment the at least one level indicator 102 is at least one ring indicator 104. In this embodiment the at least one ring indicator 104 is coupled to the housing 204 so the at least one knob 206 is in a center of the ring indicator 104. In this way, when a ring indicator 104 lights up, the light 110 corresponds to a location of the knob 206.

In another embodiment, the at least one level indicator 102 is at least one small indicator 106. In this embodiment, the at least one small indicator 106 is coupled to the housing 204 so the at least one small indicator 106 is next to a switch 208. In this way, when one of the at least one small indicator 106 lights up, the light 110 corresponds to a position of the switch 208. In the preferred embodiment, the switch 208 comprises a first position 212, a second position 214, and a third position 216. In this embodiment, the guitar effects pedal 202 comprises three small indicators 106, and each of the small indicators 106 corresponds to a position of the switch 208.

In yet another embodiment, the guitar effects pedal 202 comprises at least one slider 210. In this embodiment, a slider indicator 108 is coupled to the housing 204 at a location next to the slider 210. In this way, when the slider indicator 108 lights up, the light 110 corresponds to a position of the slider 210.

In one embodiment, the guitar effects pedal 202 may be a digital effects pedal. In another embodiment, the guitar effects pedal 202 may be a digital effects pedal.

FIG. 2B shows a guitar amplifier and FIG. 2C shows a rack speaker 218. The guitar amplifier 218 may include at least a housing 204, at least one knob 206, and at least one speaker 220. In one embodiment, the guitar amplifier 218 may also include at least one switch 208. In yet another embodiment, the guitar amplifier 218 may also include at least one slider 210. The guitar amplifier 218 may be a vacuum tube amplifier, a solid-state amplifier, an acoustic amplifier, or any other type of guitar amplifier 218 commonly known in the art.

In one embodiment, the housing 204 contains at least the communication module 112, the control module 114, a circuit, and the at least one speaker 220. The circuit may comprise any necessary components of a guitar amplifier 218 known in the art. The housing 204 may comprise metal, plastic, wood, or any other material known in the art.

In one embodiment the at least one level indicator 102 is at least one ring indicator 104. In this embodiment the at least one ring indicator 104 is coupled to the housing 204 so the at least one knob 206 is in a center of the ring indicator 104. In this way, when a ring indicator 104 lights up, the light 110 corresponds to a location of the knob 206.

In another embodiment, the at least one level indicator 102 is at least one small indicator 106. In this embodiment, the at least one small indicator 106 is coupled to the housing 204 so the at least one small indicator 106 is next to a switch 208. In this way, when one of the at least one small indicator 106 lights up, the light 110 corresponds to a position of the switch 208. In the preferred embodiment, the switch 208 comprises a first position 212, a second position 214, and a third position 216. In this embodiment, the guitar amplifier 218 comprises three small indicators 106, and each of the small indicators 106 corresponds to a position of the switch 208.

In yet another embodiment, the guitar amplifier 218 comprises at least one slider 210. In this embodiment, a slider indicator 108 is coupled to the housing 204 at as location next to the slider 210. In this way, when the slider indicator 108 lights up, the light 110 corresponds to a position of the slider 210.

FIG. 2D shows a guitar 222. The guitar 222 may include at least a housing 204, and at least one knob 206. In one embodiment, the guitar 222 may also include at least one switch 208. In yet another embodiment, the guitar may also include at least one slider 210. The guitar 222 may be an acoustic guitar, and electric guitar, a bass guitar, or any other type of guitar known in the art.

In one embodiment, the housing contains at least the communication module 112, the control module 114. In another embodiment, the housing also contains a circuit. The circuit may comprise any necessary components of a guitar 222 known in the art. The housing may comprise metal, plastic, wood, or any other material known in the art.

In one embodiment the at least one level indicator 102 is at least one ring indicator 104. In this embodiment the at least one ring indicator 104 is coupled to the housing 204 so the at least one knob 206 is in a center of the ring indicator 104. In this way, when a ring indicator 104 lights up, the light 110 corresponds to a location of the knob 206.

In another embodiment, the at least one level indicator 102 is at least one small indicator 106. In this embodiment, the at least one small indicator 106 is coupled to the housing 204 so the at least one small indicator 106 is next to a switch 208. In this way, when one of the at least one small indicator 106 lights up, the light 110 corresponds to a position of the switch 208. In the preferred embodiment, the switch 208 comprises a first position 212, a second position 214, and a third position 216. In this embodiment, the guitar 222 comprises three small indicators 106, and each of the small indicators 106 corresponds to a position of the switch 208.

In yet another embodiment, the guitar 222 comprises at least one slider 210. In this embodiment, a slider indicator 108 is coupled to the housing 204 at a location next to the slider 210. In this way, when the slider indicator 108 lights up, the light 110 corresponds to a position of the slider 210.

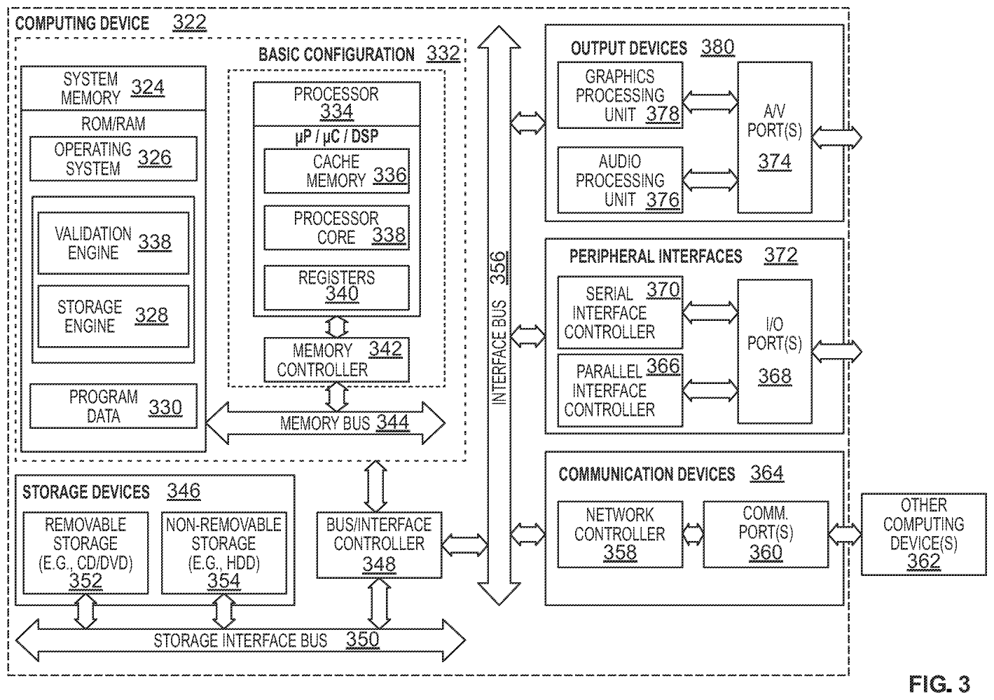

In some embodiments, the present invention may include a computing device 422 (of FIG. 3). For example, the computing device 422 may be utilized to implement a method for displaying a guitar control configuration on the computing device 422, or on a guitar rig component. A basic configuration 432 of a computing device 422 is illustrated in FIG. 3 by those components within the inner dashed line. In the basic configuration 432 of the computing device 422, the computing device 422 includes a processor 434 and a system memory 424. In some examples, the computing device 422 may include one or more processors and the system memory 424. A memory bus 444 is used for communicating between the one or more processors 434 and the system memory 424.

Depending on the desired configuration, the processor 434 may be of any type, including, but not limited to, a microprocessor (μP), a microcontroller (μC), and a digital signal processor (DSP), or any combination thereof. Further, the processor 434 may include one more level of caching, such as a level cache memory 436, a processor core 438, and registers 440, among other examples. The processor core 438 may include an arithmetic logic unit (ALU), a floating-point unit (FPU), and/or a digital signal processing core (DSP Core), or any combination thereof. A memory controller 242 may be used with the processor 434, or, in some implementations, the memory controller 442 may be an internal part of the memory controller 442.

Depending on the desired configuration, the system memory 424 may be of any type, including, but not limited to, volatile memory (such as RAM), and/or non-volatile memory (such as ROM, flash memory, etc.), or any combination thereof. The system memory 424 includes an operating system 226, one or more engines, such as the validation engine 438, and program data 43030. In some embodiments, the validation engine 438 may be an application, a software program, a service, or a software platform, as described infra.

The system memory 224 may also include a storage engine 428 that may store any information disclosed herein, such as, a guitar control configuration selection associated with a guitar control configuration, digital representations associated with the guitar 222, the guitar amplifier 218, and the guitar effects pedal 202.

Moreover, the computing device 422 may have additional features or functionality, and additional interfaces to facilitate communications between the basic configuration 432 and any desired devices and interfaces. For example, a bus/interface controller 448 is used to facilitate communications between the basic configuration 432 and data storage devices 446 via a storage interface bus 450. The data storage devices 446 may be one or more removable storage devices 452, one or more non-removable storage devices 454, or a combination thereof. Examples of the one or more removable storage devices 452 and the one or more non-removable storage devices 454 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 456 facilitates communication from various interface devices (e.g., one or more output devices 480, one or more peripheral interfaces 472, and one or more communication devices 464) to the basic configuration 432 via the bus/interface controller 456. Some of the one or more output devices 480 include a graphics processing unit 478 and an audio processing unit 476, which are configured to communicate to various external devices, such as a display or speakers, via one or more A/V ports 474.

The one or more peripheral interfaces 472 may include a serial interface controller 470 or a parallel interface controller 466, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 468.

Further, the one or more communication devices 464 may include a network controller 458, which is arranged to facilitate communication with one or more other computing devices 462 over a network communication link via one or more communication ports 460. The one or more other computing devices 462 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 424, the one or more removable storage devices 452, and the one or more non-removable storage devices 454 are examples of computer-readable storage media. The computer-readable storage media is a tangible device that can retain and store instructions (e.g., program code) for use by an instruction execution device (e.g., the computing device 422). Any such, computer storage media is part of the computing device 422.

The computer-readable storage media/medium can be a tangible device that can retain and store instructions for use by an instruction execution device. The computer-readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer-readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor 434 of a general purpose computer, special purpose computer, or other programmable data processing apparatus (e.g., the computing device 422) to produce a machine, such that the instructions, which execute via the processor 434 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 422), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method executed by a guitar control application executable on a computing device, the method comprising:
displaying at least one guitar control configuration selection;
prompting a user to select one of the at least one guitar control configuration selection;
receiving, from the user, a selection of one of the at least one guitar control configuration selection; and
in response to the selection, displaying a guitar control configuration associated with the selected guitar control configuration selection.

2. The method of claim 1, wherein the at least one guitar control configuration comprises at least one level indicator.

3. The method of claim 2, wherein the method further comprises displaying the at least one level indicator on a control on a guitar rig component.

4. The method of claim 3, wherein the guitar rig component is a guitar control pedal.

5. The method of claim 3, wherein the guitar rig component is a guitar.

6. The method of claim 3, wherein the guitar rig component is a guitar amplifier.

7. A computing device comprising:
one or more processors;
one or more memories; and
one or more computer-readable hardware storage devices, the one or more computer-readable hardware storage devices containing program code executable by the one or more processors via the one or more memories to implement a method, the method comprising:
displaying at least one guitar control configuration selection;
prompting a user to select one of the at least one guitar control configuration selection;
receiving, from the user, a selection of one of the at least one guitar control configuration selection; and
in response to the selection, displaying a guitar control configuration associated with the selected guitar control configuration selection, comprising at least one level indicator.

8. The computing device of claim 7, wherein the computer device further comprises at least one camera capable of taking at least one image.

9. The computing device of claim 8, wherein the method further comprises:
displaying the guitar control configuration on the at least one image.

10. The computing device of claim 8, wherein the method further comprises:
displaying the guitar control configuration on the at least one image, wherein the image contains at least one guitar rig component,
displaying the at least one level indicator on and/or directly next to at least one control of the guitar rig component.

11. A system comprising:
a guitar comprising a body, at least one control, and at least one level indicator, further comprising at least one light, a communication module, and a control module, wherein each of the at least one light corresponds to a position of a control of the guitar, wherein the at least one control and the at least one level indicator are disposed on the body, and the at least one level indicator is associated with at least one position of the at least one control; and
at least one guitar rig component comprising at least one guitar rig component, comprising a housing, at least one control, and at least one level indicator, further comprising at least one light, a communication module, and a control module, wherein each of the at least one light corresponds to a position of a control of at least one guitar rig component, wherein the at least one control and the at least one level indicator are disposed on the housing, and the at least one level indicator is associated with at least one position of the at least one control; and
a computing device comprising a guitar control application, the guitar control application being configured to:
display at least one guitar control configuration selection;
prompt a user to select one of the at least one guitar control configuration selection;
receive, from the user, a selection of one of the at least one guitar control configuration selection; and
in response to the selection, send a guitar control configuration associated with the selected guitar control configuration selection, to the at least one level indicator, the communication module of the at least one level indicator designed to receive the at least one configuration, and wherein the control module is designed to read the at least one configuration, and the control module is designed to light up the at least one light based on the at least one configuration.

12. The system of claim 11, wherein the at least one guitar rig component is an analog effects pedal.

13. The system of claim 11, wherein the at least one guitar rig component is a digital effects pedal.

14. The system of claim 11, wherein the at least one guitar rig component is a guitar amplifier.

15. The system of claim 11, wherein the at least one control is a knob, and the at least one light of the level indicator is disposed around the knob.

16. The system of claim 15, wherein the at least one light of the level indicator is a light emitting diode.
